(19) United States
(12) Patent Application Publication
(10) Pub. No.: US 2005/0192401 A1
(43) Pub. Date: Sep. 1, 2005

(54) Aid and method for processing thermoplastic polymer compositions

(75) Inventors: Jurgen Hauk, Freising (DE); Stefan Fokken, Biberbach (DE); Walter Reith, Egenhofen (DE); Dirk Braukmann, Dachau (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Baerlocher GmbH

(21) Appl. No.: 11/059,034

(22) Filed: Feb. 15, 2005

Related U.S. Application Data
(63) Continuation of application No. PCT/EP03/08667, filed on Aug. 5, 2003.

(30) Foreign Application Priority Data
Aug. 15, 2002 (DE) 102 37 319.1

(51) Int. Cl. C08K 5/04; C08K 3/00

(52) U.S. Cl. 524/732; 524/515

(57) ABSTRACT

The present invention is directed to processes for the preparation of a processing aid for vinyl polymers, to processing aids prepared in accordance with the process of the invention and to polymer compositions comprising such processing aids.

### CROSS-REFERENCE TO RELATED APPLICATIONS

This is a continuation application of PCT/EP2003/008667, filed Aug. 5, 2003, which is incorporated herein by reference in its entirety, and also claims the benefit of German Priority Application No. 102 37 319.1, filed Aug. 15, 2002.

### FIELD OF THE INVENTION

The present invention relates to processes for the preparation of a processing aid for vinyl polymers, to processing aids prepared in accordance with the process of the invention and to polymer compositions comprising such processing aids.

### BACKGROUND OF THE INVENTION

Soft PVC was relatively early in achieving a high stage of maturity in terms of stabilization and thermoplastic processing and has been regarded as a readily processible plastics material since the 1940s. This has been made possible by the use of plasticizers as an additive in the processing of soft PVC.

The processing of high molecular weight hard PVC, which is commonly used in the production of plastics pipes, claddings, containers or profiles, has been associated with technical problems, however, especially on account of its thermal instability and its rheological behaviour. Those problems have to some extent been solved, however, by the addition of aids. For that reason, a ready-to-process hard PVC generally consists of a mixture of different components.

Examples of aids added during the processing of hard PVC include stabilizers, lubricants and processing aids.

The stabilizers, for example, serve to counteract the damage caused to metal parts of the processing apparatus through corrosion and rust resulting from the halogen content of the PVC polymers as well as to counteract the discoloration and decomposition of moulded PVC articles caused by heat or UV radiation.

The main purpose of lubricants, however, is often to improve the flow behaviour of highly viscous PVC melts during shaping and plasticization in the various processing apparatuses, a distinction being drawn between “internal” lubricants and “external” lubricants. “External” lubricants provide a lubricating film between the plastics melt and the metal surfaces of the processing apparatus. Such a lubricating film reduces the adhesion of the individual polymer particles to the metal surfaces. In this way, it is possible to counteract degradation of the PVC caused by the rise in polymer temperatures resulting from friction between the polymer particles and the metal surfaces. “Internal” lubricants reduce the friction between polymer particles within the polymer melt and thus bring about a reduction in the effective viscosity of the polymer melt. In addition, the use of such “internal” lubricants can reduce frictional heat caused by friction between the polymer particles, which likewise has an adverse effect on the properties of the PVC.

As lubricants there are customarily used fatty alcohols, fatty acids, fatty acid amides, fats, ester waxes, acid waxes, paraffin oils, paraffin waxes or oxidised or non-oxidised polyethylene waxes.

The main purpose of processing aids, in addition to reducing the duration of the softening operation, is primarily to improve the Theological properties in the thermoplastic state and in the thermoelastic state. The processing aids, which are generally of high molecular weight, are also known as flow aids.

As processing aids there are customarily used copolymers of methyl methacrylate (MMA) with other methacrylic and acrylic acid derivatives, especially esters, or polymers based on acrylonitrile, styrene, α-methylstyrene or vinyltoluene.

For example, DE 42 20 453 A1 describes a thermoplastic composition which comprises as processing aid a copolymer based on a monomer the homopolymer of which has a glass transition temperature of ≧65° C., and on a comonomer having a C₈-C₂₂ alkyl component.

DE 199 14 605 A1 describes a copolymer used as a flow aid in the production of a plastisol, the copolymer consisting of from 0 to 90% by weight alkyl acrylates having at least 2 carbon atoms in the alkyl radical and/or styrene, from 10 to 99% by weight methyl acrylate, methyl methacrylate or ethyl acrylate, from 1 to 20% by weight of a hydrophilic compound in the form of an acrylic acid derivative, and from 0.01 to 1% by weight of a crosslinking agent.

DE 40 35 491 describes a processing aid in the form of an alkyl methacrylate copolymer having an average (weight average) molecular weight in the range of from 2,000 to <20,000.

The polymeric processing aids described in the prior art mentioned above are usually obtained by solution polymerisation, suspension polymerisation or emulsion polymerisation. Before they are added as processing aids to the thermoplastic vinyl polymers, however, the polymers have to undergo a time-consuming and expensive drying step, which in the case of emulsion polymerisation, for example, is carried out by spray-drying.

DE 21 23 384 describes a process for producing non-adhesive vinyl chloride homopolymers or copolymers in which a mixture of a polymeric acrylic ester with C₄-C₈ alcohols, a lubricant or a lubricant mixture and/or a proportion of acrylonitrile is added as additive to a vinyl chloride monomer mixture or to a vinyl chloride homopolymer or copolymer. The polymeric acrylic ester is obtained by polymerisation in the molten lubricant or by polymerisation in an aqueous emulsion. The polymeric acrylic esters described in DE 21 23 384 are added in molten or dissolved form to a PVC suspension. A disadvantage of the polyacrylates described in that document is, however, that the alcohols having a chain length ≧C₄ are partly incompatible with thermoplastic hard PVC. Furthermore, the described polymer/lubricant mixtures bring about a reduction in friction between the polymer molecules or between polymer molecules and processing apparatus, which is not desirable in the context of the present invention, however.

When halogenated polymers are being processed, however, for the purpose of better intermixing and plasticization of the polymer mass being processed it is often necessary or desirable, even in the presence of an internal lubricant, to bring about friction between the polymer molecules themselves or between the polymer mass and the walls or moving parts of the processing apparatus.

DE 20 27 124 A1 likewise relates to a process for producing non-adhesive vinyl chloride homopolymers or copolymers and moulded articles or mouldings produced therefrom. As additives there are used in this case mixtures of a polymeric acrylic ester with C₄-C₈ alcohols in the alcohol radical, lubricants or a lubricant mixture and a proportion of acrylonitrile.

The aim of the present invention was therefore to overcome the disadvantages arising from the prior art.

### SUMMARY OF THE INVENTION

The present invention was based especially on the problem of providing a process for processing thermoplastic compositions based on vinyl polymers in which processing aids can be used in the form of polyacrylates, which have satisfactory compatibility especially with PVC, without prior drying steps for the thermoplastic composition.

The invention was also based on the problem of providing a processing aid which, in addition to comprising a meltable additive, for example a lubricant or a plasticizer, comprises a processing aid which can be added to the vinyl polymers in a simple way, for example in the form of particles.

The problems underlying the invention are solved by processing aids for vinyl polymers, processes for the preparation thereof and polymer compositions, as described in the context of the following text.

The present invention therefore relates to a process for the preparation of a processing aid for vinyl polymers, in which a reaction mixture, at least comprising a (meth)acrylate monomer having from 1 to 3 carbon atoms in the alcohol radical or a monomer mixture, at least comprising a (meth)acrylate monomer having from 1 to 3 carbon atoms in the alcohol radical, and a meltable additive or a mixture of two or more meltable additives for vinyl polymers, the meltable additive or the mixture of two or more meltable additives being present in a softened state, preferably in a liquid state, under polymerization conditions, but especially having a softening temperature of more than 35° C., is free-radical-polymerized to form a reaction product at a temperature above the softening temperature of the plasticizer or the mixture of two or more plasticizers.

### DETAILED DESCRIPTION OF THE PREFERRED EMBODIMENTS

The term “(meth)acrylate” is used in the context of this text as a synonym for esters both of methacrylic acid and of acrylic acid, unless expressly indicated to the contrary.

The processing aids for vinyl polymers described in the context of this text are in principle processing aids that are suitable for use for substantially all kinds of vinyl polymers, “vinyl polymers” being understood as meaning polymers that are obtainable by polymerization of compounds having at least one olefinically unsaturated double bond.

In the context of the present invention, the term “vinyl polymers” is preferably to be understood as meaning polymers that have been obtained with the participation of at least one monomer that has at least one halogen atom.

“Vinyl polymers” in the context of the present invention are, for example, polymers selected from the group consisting of polyvinyl chloride, polymers of vinyl acetate, vinyl acetate/vinyl chloride copolymers, polymers of vinylidene halides, such as, for example, vinylidene chloride, vinyl pyridine, vinyl carbazole, styrene, vinyl benzene, polymers of acrylic acid esters, such as methyl acrylate, ethyl acrylate, or methyl methacrylate, or polymers of acrylonitrile. Especially preferred vinyl polymers are homopolymers of vinyl chloride and copolymers and terpolymers of vinyl chloride with further comonomers, such as, for example, vinyl acetate, vinyl formate, alkyl vinyl ethers, ethylene, propylene, butylene, vinylidene chloride, alkyl acrylates, alkyl methacrylates, maleic acid alkyl esters and fumaric acid alkyl esters. It is also preferred for at least 50% by weight, especially at least 75% by weight and furthermore preferably more than 90% by weight, especially substantially 100% by weight, of a vinyl polymer to be based on vinyl chloride monomers, in each case based on the weight of the vinyl polymer. The term “vinyl polymers” includes in the context of the present invention also physical mixtures of two or more different vinyl polymers, so-called blends.

For the preparation of a processing aid for vinyl polymers according to the invention, a reaction mixture, at least comprising a (meth)acrylate monomer having from 1 to 3 carbon atoms in the alcohol radical or a monomer mixture, at least comprising a (meth)acrylate monomer having from 1 to 3 carbon atoms in the alcohol radical, and a meltable additive or a mixture of two or more meltable additives for vinyl polymers is polymerized to form a reaction product, the meltable additive or the mixture of two or more meltable additives being in a softened state, preferably in a liquid state, under polymerization conditions.

Within the scope of a preferred embodiment of the present invention, the meltable additive or the mixture of two or more meltable additives has a softening temperature of more than 35° C. The polymerization is effected preferably at a temperature above the softening temperature of the meltable additive or the mixture of two or more meltable additives, for example at a temperature of at least 80° C.

In the context of the present invention, a “meltable additive” is to be understood as being in principle any additive that in admixture with vinyl polymers brings about a change in the properties of those vinyl polymers. For example, such “meltable additives” are plasticizers or lubricants. Further suitable “meltable additives” in the context of this text are mentioned, for example, in the list of suitable additional ingredients. Such meltable additives are especially compounds that have a positive effect on the processibility or the stability of vinyl polymers so treated.

A reaction mixture according to the invention comprises at least two components having different functionality. A first component, which may consist of one or more different constituents, comprises compounds having at least one olefinically unsaturated, free-radical-polymerizable double bond. Such a component is also termed the “monomer component” in the context of this text.

As at least one further component, a reaction mixture used in a process according to the invention also comprises at least one meltable additive or a mixture of two or more meltable additives, which in molten form serves as solvent in the polymerization of the monomer component.

For the preparation of a processing aid according to the invention there are suitable in principle those reaction mixtures which comprise as constituent of the monomer component at least one monomer selected from the group consisting of methyl acrylate, ethyl acrylate, propyl acrylate, methyl methacrylate, ethyl methacrylate and propyl methacrylate. Also suitable according to the invention, however, are those reaction mixtures which comprise a mixture of two or more of the above-mentioned monomers.

The proportion of compounds from the group of (meth)acrylate esters having from 1 to 3 carbon atoms in the alcohol radical in the monomer component is, in the context of the present invention, from about 0.1 to about 100% by weight, for example from about 1 to about 99% by weight or from about 5 to about 98% by weight. Within the scope of a preferred embodiment of the present invention, the proportion of compounds from the group of (meth)acrylate esters having from 1 to 3 carbon atoms in the alcohol radical in the monomer component is more than about 30% by weight, especially more than about 40% by weight or more than about 60% by weight.

In addition to comprising a compound or a mixture of two or more compounds from the group of (meth)acrylate esters having from 1 to 3 carbon atoms in the alcohol radical, in the context of the process according to the invention a monomer component may also comprise a further monomer or a mixture of two or more further monomers.

Suitable further monomers likewise have, in principle, a free-radical-polymerizable, olefinically unsaturated double bond and can be co-polymerized alternately, randomly or blockwise preferably with compounds from the group of (meth)acrylate esters having from 1 to 3 carbon atoms in the alcohol radical in the monomer component.

In principle, as further monomers there are suitable, for example, the esters of acrylic acid, methacrylic acid, ethacrylic acid, α-chloroacrylic acid, α-cyanoacrylic acid, β-methylacrylic acid (crotonic acid), α-phenylacrylic acid, β-acryloxypropionic acid, sorbic acid, α-chlorosorbic acid, 2′-methylisocrotonic acid, cinnamic acid, p-chlorocinnamic acid, β-stearylic acid, itaconic acid, citraconic acid, mesaconic acid, glutaconic acid, aconitic acid, maleic acid, fumaric acid, tricarboxylethylene and maleic anhydride, the alcohol radical of the ester having from 1 to 24 carbon atoms. Of course, the compounds from the group of (meth)acrylate esters having from 1 to 3 carbon atoms in the alcohol radical that are already necessarily present in the monomer component are excepted. Also suitable as further monomers are, for example, styrene and styrene derivatives, vinyl acetate and the like.

Within the scope of a preferred embodiment of the present invention, the monomer component used in the context of the process according to the invention comprises esters of acrylic acid or esters of methacrylic acid having 4 or more carbon atoms, for example from 4 to about 12 carbon atoms, in the alcohol radical. According to the invention it is especially preferred for the monomer component to have a content of butyl acrylate or butyl methacrylate or pentyl acrylate or pentyl methacrylate or hexyl acrylate or hexyl methacrylate or heptyl acrylate or heptyl methacrylate or octyl acrylate or octyl methacrylate or a mixture of two or more of the mentioned compounds. The alkyl radicals in the alcohol radical can be in the form of linear or branched radicals.

Within the scope of a further embodiment of the present invention, the monomer component comprises an amount of methyl methacrylate such that the resulting polymer is based on at least 50% by weight, preferably at least 75% by weight, especially at least 90% by weight and furthermore preferably 100% by weight, methyl(meth)acrylate, based on the weight of the resulting polymer. In a further embodiment of the process according to the invention, there is used as monomer component a mixture of methyl methacrylate and n-butyl(meth)acrylate in a ratio by weight of methyl methacrylate:n-butyl(meth)acrylate in a range of from 10:1 to 1:5, for example in a range of from 5:1 to 2:1.

Preferably, therefore, a monomer mixture as used in the context of the present invention contains at least 50% by weight methyl(meth)acrylate.

In addition to the monomer component, a reaction mixture used in the context of a process according to the invention also comprises a further component, namely a meltable additive or a mixture of two or more meltable additives that in the molten state serves as solvent for the polymerization. Such a component, also referred to as the “solvent component” in the context of this text, is present under the polymerization conditions that prevail in the context of the present invention in a state of aggregation that facilitates polymerization of the free-radical-polymerizable monomers. The solvent component is therefore present under the conditions prevailing in the polymerization at least in a softened state, but preferably in a liquid state. A solvent mixture in accordance with the present invention can therefore be a meltable additive or a mixture of two or more meltable additives that are present in a softened or liquid state at room temperature (23° C.).

Within the scope of a preferred embodiment of the present invention, however, the solvent component has a melting point of from at least about 25° C., but preferably at least about 30° C., to about 150° C., for example from about 40 to about 110° C. When the solvent component used in the context of the process according to the invention does not have a clearly defined melting point, the above-mentioned temperatures apply to a corresponding softening point.

It is possible for the solvent component to contain only one compound but it is also possible within the scope of the present invention for the solvent component to comprise two or more compounds as constituents. When the solvent component comprises two or more compounds, it is unnecessary for all the compounds contained in the solvent component to have a melting point within the above-mentioned range. It is sufficient for the solvent component as a whole to have a melting point or a softening point within the above-mentioned range.

In principle, in the context of the present invention there is suitable as solvent component or as a constituent of the solvent component any compound that results in the solvent component having a suitable melting range and that, furthermore, is substantially inert towards the conditions prevailing during free-radical polymerization, that is to say that does not completely suppress the course of polymerization or has no effect or no appreciable effect thereon.

It has been found in the context of the present invention that there are suitable as solvent component or at least as a constituent of the solvent component especially any compounds customarily used as “lubricant” or “plasticizer” in the processing of halogenated polymers.

Suitable lubricants are, for example, paraffin waxes, polyethylene waxes, polypropylene waxes, montan waxes, ester lubricants, such as fatty acid esters, purified or hydrogenated natural or synthetic triglycerides or partial esters, amide waxes, chloroparaffins, glycerol esters or alkaline earth soaps. Suitable lubricants are also described in “Kunststoffadditive”, R. Gächter/H. Müller, Carl Hanser Verlag, 3rd edition, 1989, pages 478-488. Also suitable as lubricants are, for example, fatty ketones, as described in DE 4,204,887, and also silicone-based lubricants, as mentioned, for example, in EP-A 0 259 783, or combinations thereof, as mentioned in EP-A 0 259 783. Reference is herewith expressly made to the said documents, the disclosure of which in respect of lubricants is to be regarded as being part of the disclosure of this text. Especially suitable in the context of the present invention are lubricants of the Baerolub® product range from Baerlocher GmbH (Unterschleiβheim, Germany).

The term “lubricant” also includes those compounds which, with a view to the properties of a composition comprising vinyl polymers, exhibit in addition to the property of improving anti-friction properties also a further or two or more further property-modifying functions.

A solvent component suitable for use according to the invention can contain the described lubricants in an amount of up to about 100% by weight, especially up to about 80% by weight, based on the total solvent component.

As plasticizers for use in a solvent component suitable for use according to the invention there are suitable, for example, compounds from the group of phthalic acid esters such as dimethyl, diethyl, dibutyl, dihexyl, di-2-ethylhexyl, di-n-octyl, diisooctyl, diisononyl, diisodecyl, dicyclohexyl, dimethylcyclohexyl, dimethylglycol, dibutylglycol, benzylbutyl or diphenyl phthalate and also mixtures of phthalates, for example mixtures of alkyl phthalates having from 7 to 9 or from 9 to 11 carbon atoms in the ester alcohol or mixtures of alkyl phthalates having from 6 to 10 and from 8 to 10 carbon atoms in the ester alcohol. Especially suitable in the context of the present invention are dibutyl, dihexyl, di-2-ethylhexyl, di-n-octyl, diisooctyl, diisononyl, diisodecyl, diisotridecyl and benzylbutyl phthalate and also the mentioned mixtures of alkyl phthalates. Also suitable are, for example, the fully or partially nucleus-hydrogenated derivatives of the above-mentioned compounds, for example nucleus-hydrogenated dioctyl phthalate, provided they are unable to participate in the free-radical polymerization or have no adverse effect or no appreciable adverse effect thereon in some other way.

Also suitable as plasticizers for use in a solvent component suitable for use according to the invention are the esters of aliphatic dicarboxylic acids, especially the esters of adipic, azelaic or sebacic acid or mixtures of two or more thereof. Examples of such plasticizers are di-2-ethylhexyl adipate, diisooctyl adipate, di-isononyl adipate, diisodecyl adipate, benzylbutyl adipate, benzyloctyl adipate, di-2-ethylhexyl azelate, di-2-ethylhexyl sebacate and diisodecyl sebacate. Within the scope of a further embodiment of the present invention, preference is given to di-2-ethylhexyl acetate and diisooctyl adipate.

Also suitable as plasticizers are trimellitic acid esters, such as tri-2-ethylhexyl trimellitate, triisotridecyl trimellitate, triisooctyl trimellitate and also trimellitic acid esters having from 6 to 8, 6 to 10, 7 to 9 or 9 to 11 carbon atoms in the ester group or mixtures of two or more of the said compounds.

Furthermore, suitable plasticizers are, for example, polymer plasticizers, as given in “Kunststoffadditive”, R. Gachter/H. Müller, Carl Hanser Verlag, 3rd edition, 1989, Chapter 5.9.6, pages 412-415, or “PVC Technology”, W. V. Titow, 4th Edition, Elsevier Publishers, 1984, pages 165-170. The most commonly used starting materials for the preparation of polyester plasticizers are, for example, dicarboxylic acids such as adipic, phthalic, azelaic or sebacic acid and diols such as 1,2-propanediol, 1,3-butanediol, 1,4-butanediol, 1,6-hexanediol, neopentyl glycol or diethylene glycol or mixtures of two or more thereof.

Also suitable as plasticizers are phosphoric acid esters, as can be found in “Taschenbuch der Kunststoffadditive”, Chapter 5.9.5, pages 408-412. Examples of suitable phosphoric acid esters are tributyl phosphate, tri-2-ethylbutyl phosphate, tri-2-ethylhexyl phosphate, trichloroethyl phosphate, 2-ethylhexyl-diphenyl phosphate, triphenyl phosphate, tricresyl phosphate and trixylenyl phosphate, or mixtures of two or more thereof.

Also suitable as plasticizers are chlorinated hydrocarbons (paraffins) or hydro-carbons as described in “Kunststoffadditive”, R. Gächter/H. Müller, Carl Hanser Verlag, 3rd edition, 1989, chapter 5.9.14.2, pages 422-425 and chapter 5.9.14.1, page 422.

Preferred lubricants are fatty alcohols, fatty acids, fatty acid esters, fatty acid amides, such as ethylene bis-stearic acid amide, natural oils and fats, ester waxes, such as montanic acid ester waxes, mineral oil, paraffin oils, paraffin waxes, oxidised or non-oxidised polyethylenes, especially polyethylene waxes, and mixtures of two or more thereof.

As fatty alcohols there are especially preferred lauryl alcohol, dodecan-1-ol, iso-tridecanol, myristyl alcohol, cetyl alcohol, palmityl alcohol, stearyl alcohol, oleyl alcohol, lauryl-myristyl alcohol, cetyl-stearyl alcohol or mixtures of at least two thereof.

As fatty acids there are used, for example, palmitic acid, stearic acid, arachic acid, behenic acid, lignoceric acid, palmitic acid, oleic acid, elaidic acid, cis-vaccenic acid, linoleic acid, α-linolenic acid, γ-linolenic acid, di-homo-γ-linolenic acid, arachidonic acid, erucic acid, nervonic acid or mixtures of at least two thereof.

Preferred fatty acid esters are the glycerol esters, especially the triglycerides, and also the glycol esters of the above-mentioned fatty acids, especially the glycerol esters of saturated fatty acids having more than about 14 carbon atoms.

Of the natural oils and fats of vegetable or animal origin there are preferably used as constituents of the solvent component employed according to the invention butter fat, lard, beef tallow, mutton tallow, goose fat, bone oil, preferably bovine bone oil, neat's foot oil, herring oil, sardine oil, sperm oil, cod liver oil, fish oil, babussu oil, olive kernel oil, rape oil, mustard oil, cottonseed oil, soya oil, linseed oil, sunflower oil, coconut oil, palm kernel oil, palm oil, avocado oil, peanut oil, sesame oil, safflower oil, maize kernel oil, grape oil, walnut oil, cocoa butter, castor oil, tung oil or mixtures of at least two thereof.

Likewise suitable as constituent of the solvent component used according to the invention are long-chain hydrocarbons as well as waxes and derivatives thereof.

Especially suitable are, for example, polyethylene waxes and derivatives thereof, for example oxidised polyethylene.

Within the scope of a further preferred embodiment of the present invention, in the process of the invention the reaction mixture comprises a triglyceride and at least one further plasticizer for vinyl polymers.

Preferred oxidised or non-oxidised polyethylenes can be characterized as oxidised and non-oxidised high density ethylene homopolymers, as acrylate- and ethylene-containing copolymers, or as acrylate-, ester- and ethylene-containing terpolymers. Especially preferred are oxidised or non-oxidised high density ethylene homopolymers. In the case of oxidised polyethylenes, they have been oxidised to give an acid number in a range of from 5 to 40, especially in a range of from 10 to 30, determined by standard titration with KOH. The polyethylenes preferably have a density in accordance with ASTM D-1505 of from 0.85 to 1.05, especially from 0.98 to 1.05. The polyethylenes preferably have a Brookfield viscosity at a temperature of 150° C. in a range of from 100 to 100,000 centipoise, especially in a range of from 1,000 to 85,000 centipoise.

In the context of the process according to the invention, the addition of the monomer or the monomer mixture of two or more monomers is preferably effected successively in a ratio by volume of from 1:500 to 1:50, based on the volume of the meltable additive or the mixture of two or more meltable additives, per minute during the reaction period.

In the context of the volumetric addition of monomer or monomer mixture “per minute during the reaction period”, based on the volume of the meltable additive or the mixture of two or more meltable additives, there should be added per minute at most 2% by volume (based on the volume of the additive) and at least 0.2% by volume (based on the volume of the additive) of monomer or monomer mixture.

For example, in the case of 100 ml of a meltable additive, preferably a maximum of 2 ml per minute and at least 0.2 ml per minute of monomer or monomer mixture (based on the volume of additive) should therefore be added.

Preferably the reaction mixture used in the context of the process according to the invention has a ratio by weight of monomer component: solvent component in a range of from about 1:10 to about 10:1, especially in a range of from about 1:5 to about 5:1 and furthermore preferably in a range of from about 1:2 to about 2:1, for example from about 1.5:1 to about 1:1.5.

Within the scope of a further embodiment of the process according to the invention, the solvent component comprises at least two, but preferably three or more constituents. It is especially preferred for the solvent component to comprise at least one triglyceride, preferably at least one saturated triglyceride. Within the scope of a further preferred embodiment, a solvent component used in a process of the invention comprises at least one oxidised polyethylene wax or at least one polyethylene wax, but preferably both.

Within the scope of a further embodiment of the present invention, a solvent component used according to the invention contains from about 30 to about 70% by weight of a triglyceride and from about 30 to about 70% by weight of a polyethylene wax or a mixture of two or more polyethylene waxes.

Within the scope of a further embodiment of the present invention there is used as solvent component, for example, a mixture of a triglyceride, especially beef tallow, a non-oxidised polyethylene wax and an oxidised polyethylene wax.

For the preparation of a processing aid in accordance with a process of the invention, a reaction mixture which comprises at least the above-described solvent component and the above-described monomer component is subjected to polymerization, the monomer component being polymerized so as to yield as reaction product a mixture of solvent component and one or more polymers, as are obtainable by polymerization of the monomer component.

The process according to the invention can in principle be carried out in any desired way, provided that there is obtained as reaction product the desired mixture of one or more polymers and a solvent component, as described in the context of this text.

For example, in the context of the process of the invention, a stabilizer for vinyl polymers can be added to the reaction mixture before or during polymerization or to the reaction product.

Preferably the meltable additive or the mixture of two or more meltable additives is in a liquid state under polymerization conditions.

One possible method of carrying out the process according to the invention comprises, for example, in a first step melting the solvent component at a temperature above the melting point or the softerning point of the solvent component, preferably under an inert gas atmosphere, especially under a nitrogen atmosphere. Then, in a second step, the monomer component and one or more polymerization initiators are added to the molten solvent component, with the result that the polymerization of the monomer component takes place.

Preferably, the meltable additive or the mixture of two or more meltable additives has a melting point of at least 30° C.

Within the scope of the present invention it is possible first to mix together solvent component and monomer component and then to add the polymerization initiator or the mixture of two or more polymerization initiators. It is equally possible, however, first to mix together the solvent component and the polymerization initiator or the mixture of two or more polymerization initiators and then to add the monomer component.

Within the scope of the process according to the invention the addition of the monomer component can in principle be effected in any desired way. For example, all of the monomer component can be added to the reaction mixture within a short period of time. It is preferred, however, within the scope of the present invention for the monomer component to be added to the reaction mixture over a longer period of time, for example over a period of from about 1 min to about 5 hours, especially over a period of from about 2 min to about 60 min, batchwise or preferably continuously, for example with addition of a static amount or with addition of an amount that varies in accordance with a gradient.

Within the scope of a preferred embodiment of the present invention, first a melt of the solvent component is prepared and then the monomer component together with the polymerization initiator is continuously added dropwise over a relatively long period of time, for example over a period of from about 5 to about 30 minutes, it having proved advantageous to dissolve or disperse the polymerization initiator in the monomer component. It is thus ensured that the reaction mixture is supplied with an unvarying concentration of monomer component and polymerization initiator.

As initiators for initiating the polymerization there may be used any initiators that form free radicals under the polymerization conditions. Initiation of polymerization by the action of electron beams on the polymerizable mixture is also possible. The polymerization can, however, also be initiated in the absence of initiators of the above-mentioned kind by the action of high-energy radiation in the presence of photoinitiators. As initiators there come into consideration all compounds known to the person skilled in the art that decompose to form free radicals. They include especially peroxides, hydroperoxides, hydrogen peroxide, persulfates, azo compounds and also so-called redox catalysts. In some cases it is advantageous to use mixtures of different polymerization initiators. Of such mixtures, preference is given to those of hydrogen peroxide and sodium or potassium peroxodisulfate, which can be used in any feasible quantity ratio. Suitable organic peroxides are especially acetylacetone peroxide, methyl ethyl ketone peroxide, tert-butyl hydroperoxide, cumene hydroperoxide, tert-amyl perpivalate, tert-butyl perpivalate, tert-butyl perneohexonate, tert-butyl isobutyrate, tert-butyl per-2-ethyl hexenoate, tert-butyl perisononanoate, tert-butyl permaleate, cumene hydroperoxide, tert-amyl perpivalate, tert-butyl perpivalate, tert-butyl perneohexonate, tert-butyl isobutyrate, tert-butyl per-2-ethyl hexenoate, tert-butyl perisononanoate, tert-butyl permaleate, tert-butyl perbenzoate, tert-butyl-3,5,5-trimethylhexanoate and amyl perneodecanoate and amyl perneodecanoate. Also preferred as polymerization initiators: azo compounds, such as 2,2′-azobis(2-amidinopropane)dihydrochloride, azo-bis-amidinopropane-dihydrochloride, 2,2′-azobis(N,N-dimethylene)isobutyramidine dihydrochloride, 2-(carbamoylazo)isobutyronitrile and 4,4′-azobis(4-cyanovaleric acid). The said compounds are used in customary amounts, preferably in a range of from 0.01 to 5 mol %, especially from 0.1 to 2 mol %, in each case based on the amount of monomer being polymerized.

The redox catalysts comprise as oxidic component at least one of the above-mentioned per compounds and as reducing component preferably ascorbic acid, glucose, sorbose, mannose, ammonium or alkali metal hydrogen sulfite, sulfate, thiosulfate, hyposulfite or sulfide, metal salts, such as iron(II) ions or silver ions or sodium hydroxymethylsulfoxylate. As the reducing component of the redox catalyst there is preferably used ascorbic acid or sodium pyrosulfite. Based on the amount of monomer used in the polymerization, there is used from 1×10⁻⁵ to 1 mol % of the reducing component of the redox catalyst and from 1×10⁻⁵ to 5 mol % of the oxidising component of the redox catalyst. Instead of the oxidising component of the redox catalyst, or in addition thereto, it is possible to use one or more azo compounds.

When the polymerization is initiated by the action of high-energy radiation, there are usually used as initiators so-called photoinitiators. These may be, for example, so-called α-cleaving agents, H-abstracting systems or azides. Examples of such initiators are benzophenone derivatives, such as Michler's ketone, phenanthrene derivatives, fluorene derivatives, anthraquinone derivatives, thioxanthone derivatives, coumarin derivatives, benzoin ethers and derivatives thereof, azo compounds such as the above-mentioned free-radical-formers, substituted hexaarylbisimidazoles or acylphosphine oxides. Examples of azides are: 2-(N,N-dimethylamino)-ethyl-4-azidocinnamate, 2-(N,N-dimethylamino)-ethyl-4-azidonaphthyl ketone, 2-(N,N-dimethylamino)-ethyl-4-azidobenzoate, 5-azido-1-naphthyl-2′-(N,N-dimethylamino)ethylsulfone, N-(4-sulfonylazidophenyl)maleinimide, N-acetyl-4-sulfonylazidoaniline, 4-sulfonylazidoaniline, 4-azidoaniline, 4-azidophenacyl bromide, p-azidobenzoic acid, 2,6-bis(p-azidobenzylidene)cyclohexanone and 2,6-bis(p-azidobenzylidene)-4-methylcyclohexanone. The photoinitiators, if used, are usually employed in amounts of from 0.01 to 5% by weight, based on the monomers being polymerized.

According to the invention there are preferably used as initiators dibenzoyl peroxide, tert-butyl peroxybenzoate, tert-butyl peroxyacetate, 3-chloroperbenzoic acid, di-(3,5,5-trimethylhexanoyl) peroxide and tert-butyl-(3,5,5-trimethylhexanoyl) peroxide.

The degree of polymerization and thus the molecular weight of the processing aid can be set by known methods, such as, for example, by the ratio of initiators to monomers or by the addition of regulators in the form of chain transfer agents. Preferred chain transfer agents are chlorinated hydrocarbons and aliphatic mercaptans, such as, for example, mercaptoethanol, mercaptopropanol, nbutylmercaptan, n-dodecylmercaptan, tert-dodecylmercaptan and thioglycolic acid 2-ethylhexyl ester.

After the polymerization, any monomers still present in the reaction mixture can be driven out of the reaction mixture by a stream of gas, preferably by a stream of nitrogen.

The polymers obtained by polymerization of the above-described monomer component in the molten solvent component preferably have at least one, especially all, of the following properties:
a) a weight average of the molecular weight (Mw) in a range of from 1×10² to 5×10⁶ g/mol (measured with GPC against a polystyrene standard);
b) a particle size in a range of from 100 to 1,000 nm (measured with a Malvern Particle Sizer).

A polymer produced in accordance with the invention can be so adjusted, for example, that it has a broad or narrow molecular weight distribution in a molecular weight range Mw of from about 1.2 to about 3.8×10⁵ g/mol (viscosity number (VN) from about 50 to about 130 cm³/g) or a broad or narrow molecular weight distribution in a molecular weight range M_{w} of from about 3.8×10⁵ to about 1.3×10⁶ g/mol (VN) from about 150 to about 330 cm³/g) or a broad or narrow molecular weight distribution in a molecular weight range M_{w} of from about 1.3×10⁶ to about 5.0×10⁶ g/mol (VN from about 330 to about 1200 cm³/g).

A polymer produced in accordance with the invention can furthermore have a monomodal, bimodal or trimodal or higher modal molecular weight distribution. Such bimodal, trimodal or higher modal molecular weight distributions can be obtained, for example, by modifying the polymerization reaction itself or by mixing together polymers of different molecular weight or different molecular weight distribution.

In a further process step, the processing aid so obtained can be cooled, for example, to room temperature. Should a solid composition be formed under those conditions, which is usually the case when the melting point of the solvent component is above room temperature, the solid composition can be converted into a particulate form, for example by comminution, for example by grinding, the processing aid being so comminuted, for example, that its particle size, determined by screen analysis, is in a range of from 1 to 2,000 μm, for example in a range of from 5 to 1,000 μm. The processing aids obtained in accordance with a process of the invention can also be processed, for example, from the molten form to give granules, prills or pastilles.

Within the scope of the present invention, the processing aids prepared in accordance with the process of the invention can consist, for example, solely of the polymer obtained from the monomer component and the solvent component. It is also possible, however, within the scope of the present invention to use the process of the invention to prepare processing aids that comprise further additional ingredients customarily used for the stabilization of polymer compositions.

In a preferred embodiment of the process according to the invention there are therefore prepared processing aids that comprise further additional ingredients, especially stabilizers, such as metal-containing stabilizers, organophosphites, acid absorbers, such as hydrotalcite, antioxidants, UV- or IR-absorbers or mixtures of at least two thereof. Further preferred additional ingredients are co-stabilizers, antistatics, lubricants, plasticizers, pigments, impact strength modifiers and fillers.

The present invention therefore relates also to processing aids that have been prepared in accordance with a process of the invention.

Suitable additional ingredients include, for example, amino alcohols. Suitable amino alcohols within the scope of the present invention are in principle any compounds having at least one OH group and a primary, secondary or tertiary amino group or a combination of two or more of the mentioned amino groups. Within the scope of the present invention, in principle both solid and liquid amino alcohols are suitable as a constituent of the processing aids according to the invention. In the context of the present invention, however, the proportion of liquid amino alcohols is, for example, so chosen that the entire processing aid is substantially in solid form.

Within the scope of a further preferred embodiment of the present invention, a processing aid according to the invention contains a maximum of approximately 5% by weight of liquid amino alcohol or a mixture of two or more liquid amino alcohols, but preferably the proportion is lower, for example 1% by weight or less. Within the scope of an especially preferred embodiment of the present invention, a processing aid according to the invention contains no liquid amino alcohol.

Amino alcohols suitable for use in the context of the present invention have, within the scope of a preferred embodiment of the present invention, a melting point higher than about 30° C., especially higher than about 50° C. Suitable amino alcohols are, for example, mono- or poly-hydroxy compounds which are based on linear or branched, saturated or unsaturated aliphatic mono- or poly-amines.

There are suitable in this connection, for example, OH-group-carrying derivatives of primary mono- or poly-amino compounds having from 2 up to about 40, for example from 6 up to about 20, carbon atoms. Examples of such derivatives are corresponding OH-group-carrying derivatives of ethylamine, n-propylamine, isopropylamine, n-propylamine, sec-propylamine, tert-butylamine, 1-aminoisobutane, and substituted amines having from 2 to about 20 carbon atoms, such as 2-(N,N-dimethylamino)-1-aminoethane. Suitable OH-group-carrying derivatives of diamines are, for example, those based on diamines having a molecular weight of from about 32 to about 200 g/mol, the corresponding diamines having at least two primary, two secondary, or one primary and one secondary amino group(s). Examples thereof are diaminoethane, the isomeric diaminopropanes, the isomeric diaminobutanes, the isomeric diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines, such as diethylenetriamine or 1,8-diamino-4-aminomethyloctane, triethylamine, tributylamine, dimethylbenzylamine, N-ethyl-, N-methyl-, N-cyclohexyl-morpholine, dimethylcyclohexylamine, dimorpholinodiethyl ether, 1,4-diazabicyclo[2,2,2]octane, 1-azabicyclo[3,3,0]octane, N,N,N′,N′-tetramethylethylenediamine, N,N,N′,N′-tetramethylbutanediamine, N,N, N′,N′-tetramethylhexane-1,6-diamine, pentamethyldiethylenetriamine, tetramethyldiaminoethyl ether, bis(dimethylaminopropyl)urea, N,N′-dimethylpiperazine, 1,2-dimethylimidazole and di(4-N,N-dimethylaminocyclohexyl)methane.

Especially suitable are aliphatic amino alcohols having from 2 to about 40, preferably from 6 to about 20, carbon atoms, for example 1-amino-3,3-dimethylpentan-5-ol, 2-aminohexane-2′,2″-diethanolamine, 1-amino-2,5-dimethylcyclohexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentane-methanol, 2-amino-2-ethyl-1,3-propanediol, 2-(dimethylaminoethoxy)-ethanol, aromatic-aliphatic or aromatic-cycloaliphatic amino alcohols having from 6 to about 20 carbon atoms, there coming into consideration as aromatic structures heterocyclic or isocyclic ring systems such as naphthalene derivatives or, especially, benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol, and also mixtures of two or more such compounds.

Within the scope of an especially preferred embodiment of the present invention, the amino alcohols used are heterocyclic compounds having a cyclic ring system containing amino groups, the OH groups being bonded to the ring either directly or preferably by way of spacers.

Within the scope of an especially preferred embodiment of the present invention there are used heterocyclic amino alcohols having at least 2, preferably at least 3, amino groups in the ring. As central ring component of the amino alcohols suitable for use according to the invention there are especially suitable the trimerisation products of isocyanates.

Special preference is given to hydroxyl-group-containing isocyanurates of the general formula I 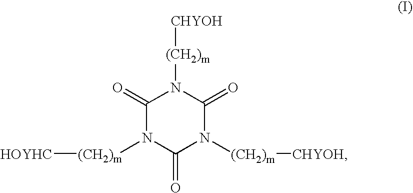
wherein the groups Y and the indices m are identical or different and m is an integer from 0 to 20 and Y is a hydrogen atom or a linear or branched, saturated or unsaturated alkyl group having from 1 to about 10 carbon atoms. In the context of the present invention special preference is given to the use of tris(hydroxymethyl)isocyanurate (THEIC) as constituent of a processing aid according to the invention.

A processing aid according to the invention may, for example, comprise only one amino alcohol. In the context of the present invention, however, a processing aid according to the invention can equally comprise a mixture of two or more different amino alcohols.

Also suitable as additional ingredients within the scope of the present invention are compounds having a structural element of the general formula II 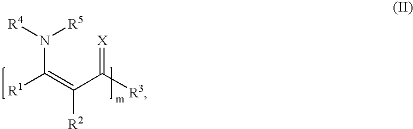
wherein n is a number from 1 to 100,000, X is O or S, the radicals R⁴, R⁵, R¹ and R² are each independently of the others hydrogen, an unsubstituted or substituted linear or branched, saturated or unsaturated aliphatic alkyl radical having from 1 to 44 carbon atoms, an unsubstituted or substituted saturated or unsaturated cycloalkyl radical having from 6 to 44 carbon atoms, an unsubstituted or substituted aryl radical having from 6 to 44 carbon atoms or an unsubstituted or substituted aralkyl radical having from 7 to 44 carbon atoms, or the radical R¹ is an unsubstituted or substituted acyl radical having from 2 to 44 carbon atoms or the radicals R¹ and R² are linked to form an aromatic or heterocyclic system and wherein the radical R³ is hydrogen, an unsubstituted or substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having from 1 to 44 carbon atoms, an unsubstituted or substituted saturated or unsaturated cycloalkyl or cycloalkylene radical or oxycycloalkyl or oxycycloalkylene radical or mercaptocycloalkyl or mercaptocycloalkylene radical or aminocycloalkyl or aminocycloalkylene radical having from 6 to 44 carbon atoms or an unsubstituted or substituted aryl or arylene radical having from 6 to 44 carbon atoms or an ether or thioether radical having from 1 to 20 O or S atoms or O and S atoms, or is a polymer that is bonded to the structural element in brackets by way of O, S, NH, NR⁴ or CH₂C(O), or the radical R³ is so linked to the radical R¹ that in total an unsubstituted or substituted, saturated or unsaturated heterocyclic ring system having from 4 to 24 carbon atoms is formed, or a mixture of two or more of the compounds of the general formula II.

Within the scope of a preferred embodiment of the present invention, as the compound of the general formula II there is used a compound based on an α,β-unsaturated β-aminocarboxylic acid, especially a compound based on β-aminocrotonic acid. Especially suitable are the esters or thioesters of corresponding aminocarboxylic acids with monovalent or polyvalent alcohols or mercaptans wherein X in each of the mentioned cases is O or S.

When the radical R³ together with X is an alcohol or mercaptan radical, such a radical can be formed, for example, from methanol, ethanol, propanol, isopropanol, butanol, 2-ethylhexanol, isooctanol, isononanol, decanol, lauryl alcohol, myristyl alcohol, palmityl alcohol, stearyl alcohol, ethylene glycol, propylene glycol, 1,3-butanediol, 1,4-butanediol, 1,6-hexanediol, 1,10-decanediol, diethylene glycol, thiodiethanol, trimethylolpropane, glycerol, tris(2-hydroxymethyl)isocyanurate, triethanolamine, pentaerythritol, di-trimethylolpropane, diglycerol, sorbitol, mannitol, xylitol, di-pentaerythritol and also the corresponding mercapto derivatives of the mentioned alcohols.

Within the scope of an especially preferred embodiment of the present invention, as the compound of the general formula II there is used a compound in which R¹ is a linear alkyl radical having from 1 to 4 carbon atoms, R² is hydrogen and R³ is a linear or branched, saturated, mono- to hexa-valent alkyl or alkylene radical having from 2 to 12 carbon atoms or a linear, branched or cyclic 2- to 6-valent ether alcohol radical or thioether alcohol radical.

Suitable compounds of the general formula II include, for example, β-aminocrotonic acid stearyl ester, 1,4-butanediol di(β-aminocrotonic acid)ester, thiodiethanol-β-aminocrotonic acid ester, trimethylolpropane tri-β-aminocrotonic acid ester, pentaerythritol-tetra-β-aminocrotonic acid ester, dipentaerythritol-hexa-β-aminocrotonic acid ester and the like. The mentioned compounds can be present in a processing aid according to the invention singly or as a mixture of two or more thereof.

Compounds that are likewise suitable as compounds of the general formula II within the scope of the present invention are aminouracil compounds of the general formula II 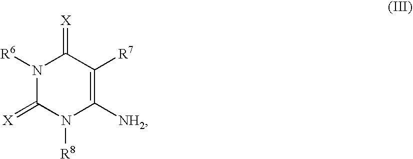
wherein X is S or O and wherein the radicals R⁶ and R⁷ are each independently of the other hydrogen, an unsubstituted or substituted linear or branched, saturated or unsaturated aliphatic alkyl radical having from 1 to 44 carbon atoms, an unsubstituted or substituted saturated or unsaturated cycloalkyl radical having from 6 to 44 carbon atoms, an unsubstituted or substituted aryl radical having from 6 to 44 carbon atoms or an unsubstituted or substituted aralkyl radical having from 7 to 44 carbon atoms and the radical R³ is hydrogen, an unsubstituted or substituted linear or branched, saturated or unsaturated aliphatic hydrocarbon radical having from 1 to 44 carbon atoms, an unsubstituted or substituted saturated or unsaturated cycloaliphatic hydrocarbon radical having from 6 to 44 carbon atoms or an unsubstituted or substituted aromatic hydrocarbon radical having from 6 to 44 carbon atoms.

The compound according to formula III thus falls within the scope of the compounds according to formula II wherein n in the general formula II is 1 and the radicals R¹ and R³ according to the general formula II are linked to form the structural element of the general formula IV 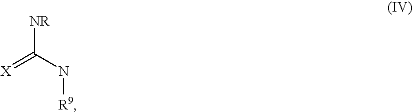
wherein X is S or O and R is R⁶ or R⁸. R¹ in the case of a compound of the general formula IV is therefore N—R⁹, while R³ is —RN—C═X and the two radicals are covalently linked by way of a N—C bond to form a heterocyclic ring.

In the context of the present invention it is preferable to use compounds of the general formula IV wherein R⁹ is hydrogen.

Within the scope of a further preferred embodiment of the present invention, in a processing aid according to the invention there are used compounds of the general formula III wherein R⁶ and R⁸ are a linear or branched alkyl radical having from 1 to 6 carbon atoms, for example methyl, ethyl, propyl, butyl, pentyl or hexyl, an OH-group-substituted linear or branched alkyl radical having from 1 to 6 carbon atoms, for example hydroxymethyl, hydroxyethyl, hydroxypropyl, hydroxybutyl, hydroxypentyl or hydroxyhexyl, an aralkyl radical having from 7 to 9 carbon atoms, for example benzyl, phenylethyl, phenylpropyl, dimethylbenzyl or phenylisopropyl, it being possible for the mentioned aralkyl radicals to be substituted, for example, by halogen, hydroxy or methoxy, or an alkenyl radical having from 3 to 6 carbon atoms, for example vinyl, alkyl, methallyl, 1-butenyl or 1-hexenyl.

Within the scope of a preferred embodiment of the present invention, in a processing aid according to the invention there are used compounds of the general formula III wherein R⁶ and R⁸ are hydrogen, methyl, ethyl, n-propyl, isopropyl, n-, iso-, sec- or tert-butyl.

Also suitable as compounds of the general formula II are, for example, compounds in which the radicals R¹ and R² are linked to form an aromatic or heteroaromatic system, for example aminobenzoic acid, aminosalicylic acid or aminopyridinecarboxylic acid and suitable derivatives thereof.

Further suitable additional ingredients in the context of the present invention are, for example, compounds having at least one mercapto-functional, sp²-hybridised carbon atom. Compounds having at least one mercapto-functional, sp²-hybridised carbon atom are to be understood in the context of the present invention as being in principle any compounds having a structural element Z═CZ-SH or a structural element Z₂C═S, it being possible for the two structural elements to be tautomeric forms of a single compound. The sp²-hybridised carbon atom may be a constituent of an unsubstituted or substituted aliphatic compound or a constituent of an aromatic system. Accordingly Z is an aliphatic compound or a constituent of an aliphatic compound or a constituent of an aromatic system. Suitable types of compound are, for example, thiocarbamic acid derivatives, thiocarbamates, thiocarboxylic acids, thiobenzoic acid derivatives, thioacetone derivatives and thiourea or thiourea derivatives. Suitable compounds having at least one mercapto-functional, sp²-hybridised carbon atom are mentioned, for example, in the non-prior-published German patent application having the file reference 101 09 366.7. Within the scope of a preferred embodiment of the present invention, thiourea or a thiourea derivative is used as the compound having at least one mercapto-functional, sp²-hybridised carbon atom.

Examples of additional ingredients also suitable for a processing aid according to the invention are carbazole and carbazole derivatives or mixtures of two or more thereof.

Further suitable additional ingredients are, for example, 2,4-pyrrolidinedione or derivatives thereof, such as are mentioned, for example, in the non-prior-published German patent application having the file reference 101 09 366.7.

Also suitable as additional ingredients are, for example, epoxy compounds. Examples of such epoxy compounds are epoxidised soybean oil, epoxidised olive oil, epoxidised linseed oil, epoxidised castor oil, epoxidised groundnut oil, epoxidised maize oil, epoxidised cottonseed oil, and also glycidyl compounds. Glycidyl compounds contain a glycidyl group that is bonded directly to a carbon, oxygen, nitrogen or sulfur atom. Glycidyl or methylglycidyl esters are obtainable by reaction of a compound having at least one carboxyl group in the molecule and epichlorohydrin or glycerol dichlorohydrin or methyl-epichlorohydrin. The reaction is advantageously carried out in the presence of bases.

As compounds having at least one carboxyl group in the molecule there can be used, for example, aliphatic carboxylic acids. Examples of such carboxylic acids are glutaric acid, adipic acid, pimelic acid, suberic acid, azelaic acid, sebacic acid or dimerised or trimerised linoleic acid, acrylic acid, methacrylic acid, caproic acid, caprylic acid, lauric acid, myristic acid, palmitic acid, stearic acid or pelargonic acid and also the mono- or poly-carboxylic acids mentioned hereinbelow. Also suitable are cycloaliphatic carboxylic acids, such as cyclohexanecarboxylic acid, tetrahydrophthalic acid, 4-methyltetrahydrophthalic acid, hexahydrophthalic acid, endomethylenetetrahydrophthalic acid or 4-methylhexahydrophthalic acid. Also suitable are aromatic carboxylic acids, such as benzoic acid, phthalic acid, isophthalic acid, trimellitic acid or pyromellitic acid.

Glycidyl ethers or methylglycidyl ethers can be obtained by reaction of a compound having at least one free alcoholic OH group or a phenolic OH group and a suitably substituted epichlorohydrin under alkaline conditions or in the presence of an acidic catalyst and subsequent alkali treatment. Ethers of this type are derived, for example, from acyclic alcohols, such as ethylene glycol, diethylene glycol or higher poly(oxyethylene)glycols, propane-1,2-diol or poly(oxypropylene)glycols, butane-1,4-diol, poly(oxytetramethylene)glycols, pentane-1,5-diol, hexane-1,6-diol, hexane-2,4,6-triol, glycerol, 1,1,1-trimethylolpropane, bis-trimethylolpropane, pentaerythritol, sorbitol, and also from polyepichlorohydrins, butanol, amyl alcohol, pentanol, and also from monofunctional alcohols, such as isooctanol, 2-ethylhexanol, isodecanol or technical alcohol mixtures, for example technical fatty alcohol mixtures.

Suitable ethers are also derived from cycloaliphatic alcohols, such as 1,3- or 1,4-dihydroxycyclohexane, bis(4-hydroxycyclohexyl)methane, 2,2-bis(4-hydroxycyclohexyl)propane or 1,1-bis(hydroxymethyl)cyclohexan-3-ene, or they have aromatic nuclei, such as N,N-bis(2-hydroxyethyl)aniline. Suitable epoxy compounds can also be derived from mononuclear phenols, for example from phenol, resorcinol or hydroquinone, or they are based on polynuclear phenols, such as bis(4-hydroxyphenyl)methane, 2,2-bis(4-hydroxyphenyl)propane, 2,2-bis(3,5-dibromo-4-hydroxyphenyl)propane, 4,4′-dihydroxydiphenylsulfones, or on condensation products of phenol with formaldehyde obtained under acidic conditions, for example phenol novolaks.

Further terminal epoxides suitable as additional ingredients in the context of the present invention are, for example, glycidyl-1-naphthyl ether, glycidyl-2-phenyl phenyl ether, 2-diphenylglycidyl ether, N-(2,3-epoxypropyl)phthalimide and 2,3-epoxypropyl-4-methoxyphenyl ether.

Also suitable are N-glycidyl compounds, such as are obtainable by dehydrochlorination of the reaction products of epichlorohydrin with amines containing at least one amino hydrogen atom. Such amines are, for example, aniline, N-methylaniline, toluidine, n-butylamine, bis(4-aminophenyl)methane, m-xylylenediamine or bis(4-methylaminophenyl)methane.

Likewise suitable are S-glycidyl compounds, for example di-S-glycidyl ether derivatives, that are derived from dithiols, such as ethane-1,2-dithiol or bis(4-mercaptomethylphenyl)ether.

Especially suitable epoxy compounds are described, for example, on pages 3 to 5 of EP-A 1 046 668, reference being expressly made to the disclosure contained therein, which is to be regarded as part of the disclosure of this text.

Also suitable as additional ingredients in the context of the present invention are 1,3-dicarbonyl compounds, especially the β-diketones and β-keto esters. Suitable in the context of the present invention are dicarbonyl compounds of the general formula R′C(O)CHR″—C(O)R′″, as described, for example, on page 5 of EP 1 046 668, to which reference is expressly made especially in respect of the radicals R′, R″ and R′″ and the disclosure of which is regarded as being part of the disclosure of this text. Especially suitable are, for example, acetyl acetone, butanoyl acetone, heptanoyl acetone, stearoyl acetone, palmitoyl acetone, lauroyl acetone, 7-tertnonylthioheptane-2,4-dione, benzoyl acetone, dibenzoylmethane, lauroylbenzoylmethane, palmitoylbenzoylmethane, stearoylbenzoylmethane, isooctylbenzoylmethane, 5-hydroxycapronylbenzoylmethane, tribenzoylmethane, bis(4-methylbenzoyl)methane, benzoyl-p-chlorobenzoylmethane, bis(2-hydroxybenzoyl)methane, 4-methoxybenzoylbenzoylmethane, bis(4-methoxybenzoyl)methane, benzoylformylmethane, benzoylacetylphenylmethane, 1-benzoyl-1-acetylnonane, stearoyl-4-methoxybenzoylmethane, bis(4-tert-butylbenzoyl)methane, benzoylphenylacetylmethane, bis(cyclohexanoyl)methane, dipivaloylmethane, 2-acetylcyclopentanone, 2-benzoylcyclopentanone, diacetoacetic acid methyl, ethyl, butyl, 2-ethylhexyl, dodecyl or octadecyl ester and also propionyl or butyryl acetic acid esters having from 1 to 18 carbon atoms, and also stearoyl acetic acid ethyl, propyl, butyl, hexyl or octyl esters or polynuclear β-keto esters, as described in EP-A 433 230, to which reference is expressly made, or dehydracetic acid and also the zinc, magnesium or alkali salts thereof or the alkali, alkaline earth or zinc chelates of the mentioned compounds insofar as they exist.

1,3-Diketo compounds can be present in a processing aid according to the invention in an amount of up to about 20% by weight, for example up to about 10% by weight.

Polyols are also suitable as additional ingredients. Suitable polyols are, for example, pentaerythritol, dipentaerythritol, tripentaerythritol, bis-trimethylolpropane, inositol, polyvinyl alcohol, bistrimethylolethane, trimethylolpropane, sorbitol, maltitol, isomaltitol, lactitol, lycasine, mannitol, lactose, leucrose, tris(hydroxymethyl) isocyanurate, palatinite, tetramethylolcyclohexanol, tetramethylolcyclopentanol, tetramethylolcycloheptanol, glycerol, diglycerol, polyglycerol, thiodiglycerol or 1-0-α-D-glycopyranosyl-D-mannitol dihydrate.

Also suitable as additional ingredients are, for example, sterically hindered amines, such as those mentioned on pages 7 to 27 of EP-A 1 046 668. Reference is expressly made to the sterically hindered amines disclosed therein, the compounds mentioned therein being regarded as part of the disclosure of this text.

The sterically hindered amines suitable as additional ingredients can be present in a processing aid according to the invention in an amount of up to approximately 30% by weight, for example up to approximately 10% by weight.

Also suitable as additives are hydrotalcites, zeolites and alkali alumocarbonates. Suitable hydrotalcites, zeolites and alkali alumocarbonates are described, for example, on pages 27 to 29 of EP-A 1 046 668, on pages 3, 5 and 7 of EP-A 256 872, on pages 2 and 3 of DE-C 41 06 411 and on pages 2 and 3 of DE-C 41 06 404. Reference is expressly made to those specifications, and their disclosure at the indicated places is regarded as being part of the disclosure of this text.

The hydrotalcites, zeolites and alkali alumocarbonates suitable as additives can be present in a processing aid according to the invention in an amount of up to approximately 50% by weight, for example up to approximately 30% by weight.

Also suitable as additional ingredients are, for example, hydrocalumites of the general formula V
M²⁺₍₂₊ₓ₎Al³⁺_{(1+y)}(OH)_{(6+z)}A^{j-}ₐ[Bᵣ]^{nl}_{b}*mH₂O (V),
wherein M is calcium, magnesium or zinc or a mixture of two or more thereof, A is a j-valent inorganic or organic acid anion, j is 1, 2 or 3, B is an inorganic or organic acid anion other than A, r is a whole number ≧1 and, when is r>1, indicates the degree of polymerization of the acid anion, and l is 1, 2, 3 or 4 and indicates the valency of the acid anion, where, for r=1, l is 2, 3 or 4 and, for r>1, l indicates the valency of the individual monomer units of the polyanion and is 1, 2, 3 or 4 and rl indicates the total valency of the polyanion, and the following rules apply to the parameters x, y, a, b, r, z and j:
0≦x<0.6,
0≦y<0.4, where either x=0 or y=0,
0<a<0.8/r, and
z=1+2x+3y−ja−r/b.

Within the scope of a preferred embodiment of the present invention, as additional ingredients there are used compounds of the general formula V wherein M is calcium, which may be in admixture with magnesium or zinc or magnesium and zinc.

In the general formula V, A is an r-valent inorganic or organic acid anion, wherein r is 1, 2 or 3. Examples of acid anions present in the context of hydrocalumites suitable for use according to the invention are halide ions, SO₃²⁻, SO₄²⁻, S₂O₃²⁻, S₂O₄²⁻, HPO₃²⁻, PO₄³⁻, CO₃²⁻, perchlorates, borates, alkyl and dialkyl phosphates, alkyl mercaptides and alkyl sulfonates, wherein the alkyl groups may be identical or different, straight-chain, branched or cyclic and preferably have from 1 to about 20 carbon atoms. Also suitable as acid anions A are the anions of optionally functionalised di-, tri- or tetra-carboxylic acids, such as maleate, phthalate, aconitate, trimesate, pyromellitate, maleate, tartrate, citrate and also anions of the isomeric forms of hydroxyphthalic acid or hydroxymesic acid. Within the scope of a preferred embodiment of the present invention, A is an inorganic acid anion, especially a halide ion, for example F⁻, Cl⁻ or Br⁻, preferably Cl⁻.

In the general formula V, B is an acid anion other than A. For the case where r in the general formula V is the number 1, the letter B denotes an 1-valent inorganic or organic acid anion, wherein l is the number 2, 3 or 4. Examples of acid anions B present in the context of compounds of the general formula V suitable for use according to the invention are, for example, O²⁻, SO₃²⁻, SO₄²⁻, S₂O₃²⁻, S₂O₄²⁻, HPO₃²⁻, PO₄³⁻, CO₃²⁻, alkyl and dialkyl phosphates, alkyl mercaptides and alkyl sulfonates, wherein the alkyl groups may be identical or different, straight-chained or branched or cyclic and preferably have from 1 to about 20 carbon atoms. Also suitable as acid anions A are the anions of optionally functionalised di-, tri- or tetra-carboxylic acids, such as maleate, phthalate, aconitate, trimesate, pyromellitate, maleate, tartrate, citrate, and also anions of the isomeric forms of hydroxyphthalic acid or hydroxymesic acid. B in the context of the present invention in formula V is preferably a borate or an anion of an optionally functionalised di-, tri- or tetra-carboxylic acid. Special preference is given to carboxylic acid anions and anions of hydroxycarboxylic acids having at least two carboxyl groups, very special preference being given to citrates.

For the case where r in the general formula V is a number greater than 1, the term [Bᵣ]^{rl-} denotes an inorganic or organic polyanion having a degree of polymerization r and the valency l of the individual monomer units of the polyanion with the total valency rl, wherein l is equal to or greater than 1. Examples of suitable polyanions [Br]rl−are polyacrylates, polycarboxylates, polyborates, polysilicates, polyphosphates and polyphosphonates.

In all the above-mentioned cases, the acid anions A and B can be present in any desired ratio a/b in the compounds of the general formula V.

The compounds of the general formula V are not compounds having a layered structure of the hydrotalcite or hydroalumite type but a physical mixture of M²⁺/aluminium oxide hydrates with salts of divalent metals. X-ray diffractograms of the compounds of the general formula V used in the composition according to the invention clearly show that they are not discrete crystalline compounds of a known type but mixtures that are amorphous to X-rays.

For the preparation of the compounds according to the general formula V, by following known procedures, solutions or suspensions of oxidic forms of the desired cations (e.g. NaAlO₂, Ca(OH)₂, Zn(OH)₂, Al(OH)₃) can be mixed with solutions or suspensions of salts or the corresponding acids of the desired anions and reacted at temperatures of from 40 to 95° C., it being possible for the reaction times to be varied between 15 and 300 minutes.

When surface-treatment of the reaction products is desired, the surface-treatment medium can be added directly to the reaction products and the product can be separated from the mother liquor by filtration and dried at suitable temperatures between 100 and 250° C. The added amount of surface-treatment medium is, for example, from about 1 to about 20% by weight.

Compounds of the general formula V can be used in a processing aid according to the invention in an amount of up to about 50% by weight, for example up to about 30% by weight or up to about 15% by weight.

Also suitable as additional ingredients are metal oxides, metal hydroxides and metal soaps of saturated, unsaturated, straight-chain or branched, aromatic, cycloaliphatic or aliphatic carboxylic acids or hydroxycarboxylic acids having especially from about 2 to about 22 carbon atoms.

As metal cations, the metal oxides, metal hydroxides or metal soaps suitable as additional ingredients have especially a divalent cation; the cations of calcium or zinc or mixtures thereof are especially suitable.

Examples of suitable carboxylic acid anions include anions of monovalent carboxylic acids, such as acetic acid, propionic acid, butyric acid, valeric acid, hexanoic acid, oenanthic acid, octanoic acid, neodecanoic acid, 2-ethylhexanoic acid, pelargonic acid, decanoic acid, undecanoic acid, dodecanoic acid, tridecanoic acid, myristic acid, palmitic acid, lauric acid, isostearic acid, stearic acid, 12-hydroxystearic acid, 9,10-dihydroxystearic acid, oleic acid, 3,6-dioxaheptanoic acid, 3,6,9-trioxadecanoic acid, behenic acid, benzoic acid, p-tert-butylbenzoic acid, dimethylhydroxybenzoic acid, 3,5-di-tert-butyl-4-hydroxybenzoic acid, toluic acid, dimethylbenzoic acid, ethylbenzoic acid, n-propylbenzoic acid, salicylic acid, p-tertoctylsalicylic acid, sorbic acid, anions of divalent carboxylic acids or monoesters thereof, such as oxalic acid, malonic acid, maleic acid, tartaric acid, cinnamic acid, mandelic acid, malic acid, glycolic acid, oxalic acid, salicylic acid, polyglycoldicarboxylic acids having a degree of polymerization of from about 10 to about 12, phthalic acid, isophthalic acid, terephthalic acid or hydroxyphthalic acid, anions of tri- or tetra-valent carboxylic acids or mono-, di- or tri-esters thereof, as in hemimellitic acid, trimellitic acid, pyromellitic acid or citric acid, and also so-called overbased carboxylates as described, for example, in DE-A 41 06 404 or DE-A 40 02 988, the disclosure of the last-mentioned documents being regarded as part of the disclosure of this text.

A processing aid according to the invention can furthermore comprise as thermostabilizer component an organotin compound or a mixture of two or more organotin compounds. Suitable organotin compounds are, for example, methyltintris(isooctyl-thioglycolate), methyltin-tris(isooctyl-3-mercaptopropionate), methyltintris(isodecyl-thioglycolate), dimethyltin-bis(isooctyl-thioglycolate), dibutyltin-bis(isooctyl-thioglycolate), monobutyltin-tris(isooctyl-thioglycolate), dioctyltinbis(isooctyl-thioglycolate), monooctyltin-tris(isooctyl-thioglycolate) or dimethyltinbis(2-ethylhexyl-β-mercaptopropionate).

Furthermore, it is possible to use as additional ingredients the organotin compounds which are mentioned and the preparation of which is described on pages 18 to 29 of EP-A 0 742 259. Reference is expressly made to the above-mentioned disclosure, the compounds mentioned therein and their preparation being understood as being part of the disclosure of this text.

A processing aid according to the invention can comprise the described organotin compounds in an amount of up to about 20% by weight, especially up to about 10% by weight.

Within the scope of a further embodiment of the present invention, a processing aid according to the invention can comprise organic phosphite esters having from 1 to 3 organic radicals, two or more of which radicals may be identical or all of which may be different. Suitable organic radicals are, for example, linear or branched, saturated or unsaturated alkyl radicals having from 1 to 24 carbon atoms, unsubstituted or substituted alkyl radicals having from 6 to 20 carbon atoms or unsubstituted or substituted aralkyl radicals having from 7 to 20 carbon atoms. Examples of suitable organic phosphite esters are tris(nonylphenyl), trilauryl, tributyl, trioctyl, tridecyl, tridodecyl, triphenyl, octyldiphenyl, dioctylphenyl, tri(octylphenyl), tribenzyl, butyidicresyl, octyl-di(octylphenyl), tris(2-ethylhexyl), tritolyl, tris(2-cyclohexylphenyl), tri-α-naphthyl, tris(phenylphenyl), tris(2-phenylethyl), tris(dimethylphenyl), tricresyl or tris(p-nonylphenyl)phosphite or tristearyl sorbitoltriphosphite or mixtures of two or more thereof.

A processing aid according to the invention can comprise the described phosphite compounds in an amount of up to about 30% by weight, especially up to about 10% by weight.

A processing aid according to the invention can also comprise as additional ingredients blocked mercaptans, as mentioned on pages 4 to 18 of EP-A 0 742 259. Reference is expressly made to the disclosure in the specification indicated, which is understood as being part of the disclosure of this text.

A processing aid according to the invention can comprise the described blocked mercaptans in an amount of up to about 30% by weight, especially up to about 10% by weight.

Antioxidants that are likewise suitable as additional ingredients are preferably phenolic antioxidants, such as, for example, 2,6-di-tert-butyl-4-methylphenol, styrenated phenol, 2,2′-methylene-bis(4-methyl-6-tert-butylphenol), 2,2′-bis(4-hydroxyphenol)propane, octadecyl-3-(3′,5′-di-tert-butyl-4-hydroxyphenol)propionates or pentaerythritol-tetrakis(3′,5′-di-tert-butyl-4-hydroxyphenol)propionate.

As UV absorbers having a stabilizing action there are preferably used as additional ingredients benzophenones, such as, for example, 2-hydroxy-4-methoxybenzophenone or 2-hydroxy-4-octyloxybenzophenone, benzotriazoles, such as, for example, 2-(2′-hydroxy-5′-methylphenyl)benzotriazole, salicylates, such as, for example, phenyl salicylate, nickel salts, such as, for example, nickelbis(octylphenylsulfide) or nickel-bis[O-ethyl(3,5-di-tert-butyl-4-hydroxybenzyl)]phosphonate, or sterically hindered amines, such as, for example, bis(2,2,6,6-tetramethylpiperidinyl-4) sebacate. Preferred IR-absorbers as stabilizers are 2-hydroxy-4-octyloxybenzophenone and ethyl-2-cyano-3,3-diphenyl acrylate.

Also suitable as additional ingredients are inorganic or organic perchlorates.

As inorganic perchlorates there are suitable, for example, halogen-containing salts of oxy acids, especially the perchlorates. Examples of suitable perchlorates are those of the general formula M(ClO₄)ₙ, wherein M is Li, Na, K, Mg, Ca, Sr, Zn, Al, La or Ce. The index n, according to the valency of M, is the number 1, 2 or 3. The mentioned perchlorate salts can be complexed with alcohols (polyols, cyclodextrins) or ether alcohols or ester alcohols. Ester alcohols also include the polyol partial esters. Suitable polyvalent alcohols or polyols also include their dimers, trimers, oligomers and polymers, such as di-, tri-, tetra- and poly-glycols, and also di-, tri- and tetra-pentaerythritol or polyvinyl alcohol in various degrees of polymerization and hydrolysis. As polyol partial esters preference is given to glycerol monoethers and glycerol monothioethers. Also suitable are sugar alcohols and thio sugars.

As organic perchlorates there are suitable, for example, the onium salts of perchloric acid. In the context of this text, the term “onium salt” denotes a compound that is an ammonium, sulfonium or phosphonium salt. An “onium salt” in accordance with the present invention is an organic onium salt. That means that the ammonium, sulfonium or phosphonium group of the onium salt carries at least one organic radical. An onium salt in accordance with the present invention may carry 1, 2, 3 or 4 organic radicals according to the nature of the onium group. The organic radicals can be bonded to the onium radical, for example, by way of a C—X linkage, where X is S, N or P. It is equally possible, however, for the organic radicals to be bonded to the onium radical by way of a further hetero atom, for example an O atom.

An onium perchlorate suitable for use within the scope of the present invention has at least one positively charged N, P or S atom or two or more such positively charged N, P or S atoms or mixtures of two or more of the mentioned positively charged atom types.

As phosphonium perchlorates there are in principle suitable for use within the scope of the present invention any compounds which, by appropriate reaction of suitable reactants, result in a phosphonium perchlorate. Phosphonium perchlorates suitable for use according to the invention can be obtained, for example, by appropriate reaction of tetraalkyl-, tetracycloalkyl- or tetraaryl-phosphorus halides. Suitable phosphonium perchlorates are therefore derived, for example, from tetraalkylphosphorus salts, such as tetra-n-ethylphosphonium bromide, tetra-npropylphosphonium bromide, tetra-n-butylphosphonium bromide, tetra-n-isobutylphosphonium bromide, tetra-n-pentylphosphonium bromide, tetra-n-hexyl-phosphonium bromide and like tetraalkylphosphorus salts. Also suitable in principle for use within the scope of the stabilizer compositions according to the invention are phosphonium perchlorates derived, for example, from tetracycloalkylphosphorus salts or tetraarylphosphorus salts. Suitable phosphonium perchlorates are therefore based, for example, on tetracycloalkyl- or tetraaryl-phosphorus salts such as tetracyclohexylphosphonium bromide or tetraphenylphosphonium bromide and like tetracycloalkyl- or tetraaryl-phosphorus salts.

As sulfonium perchlorates there are in principle suitable for use within the scope of the present invention any compounds which, by appropriate reaction of suitable reactants, result in a sulfonium perchlorate. Sulfonium perchlorates suitable for use according to the invention can be obtained, for example, by appropriate reaction of sulfides such as alkyl monosulfides, alkyl disulfides, dialkyl sulfides or poly(alkylsulfides). Suitable sulfonium perchlorates are therefore derived, for example, from dialkyl sulfides such as ethylbenzyl sulfide, allylbenzyl sulfide or alkyldisulfides such as hexane disulfide, heptane disulfide, octane disulfide and like alkyl disulfides. Also suitable in principle for use within the scope of the stabilizer compositions according to the invention are sulfonium perchlorates derived, for example, from tricycloalkylsulfonium salts or triarylsulfonium salts. Suitable sulfonium perchlorates are therefore based, for example, on tricycloalkyl- or triarylsulfonium salts such as tricyclohexylsulfonium bromide or triphenylsulfonium bromide and like tricycloalkyl- or triaryl-sulfonium salts. Also suitable are trialkyl-, triaryl- or tricycloalkyl-sulfoxonium salts such as trimethylsulfoxonium perchlorate.

As ammonium perchlorates there are in principle suitable for use within the scope of the present invention any compounds which, by appropriate reaction of suitable reactants, result in an ammonium perchlorate. Ammonium perchlorates suitable for use in accordance with the invention can be obtained, for example, by appropriate reaction of amines or amides such as alkyl monoamines, alkylenediamines, alkyl polyamines, or secondary or tertiary amines. Suitable ammonium perchlorates are therefore derived, for example, from primary mono- or poly-amino compounds having from 2 to about 40 carbon atoms, for example from 6 to about 20 carbon atoms. Examples thereof are ethylamine, n-propylamine, isopropylamine, n-butylamine, sec-butylamine, tert-butylamine, and substituted amines having from 2 to about 20 carbon atoms, such as 2-(N,N-dimethylamino)-1-aminoethane. Suitable diamines have, for example, two primary, two secondary, two tertiary or one primary and one secondary or one primary and one tertiary or one secondary and one tertiary amino group. Examples thereof are diaminoethane, the isomeric diaminopropanes, the isomeric diaminobutanes, the isomeric diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane or tertiary amines such as triethylamine, tributylamine, trihexylamine, triheptylamine, trioctylamine, dimethylbenzylamine, N-ethyl-, N-methyl-, N-cyclohexyl-morpholine, dimethylcyclohexylamine, dimorpholinodiethyl ether, 1,4-diazabicyclo[2,2,2]octane, 1-azabicyclo[3,3,0]octane, N,N,N′,N′-tetramethylethylenediamine, N,N,N′,N′-tetramethylbutanediamine, N,N, N′,N′-tetramethylhexane-1,6-diamine, pentamethyldiethylenetriamine, tetramethyldiaminoethyl ether, bis(dimethylaminopropyl)urea, N,N′-dimethylpiperazine, 1,2-dimethylimidazole or di(4-N,N-dimethylaminocyclohexyl)methane.

Especially suitable and preferred in the context of the present invention are aliphatic amino alcohols having from 2 to about 40 carbon atoms, preferably from 6 to about 20 carbon atoms, for example triethanolamine, tripropanolamine, triisopropanolamine, tributanolamine, tri-tert-butanolamine, tripentanolamine, 1-amino-3,3-dimethyl-pentan-5-ol, 2-aminohexane-2′,2″-diethanolamine, 1-amino-2,5-dimethylcyclohexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentane-methanol, 2-amino-2-ethyl-1,3-propanediol, 2-(dimethylaminoethoxy)-ethanol, and aromatic-aliphatic or aromatic-cycloaliphatic amino alcohols having from 6 to about 20 carbon atoms, there being used as aromatic structures heterocyclic or isocyclic ring systems such as naphthalene derivatives or, especially, benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol and also mixtures of two or more such compounds.

The mentioned additional ingredients can be used in the processing aid according to the invention in total in an amount of from about 0.01 to about 70% by weight, especially in an amount in a range of from 0.1 to about 50% by weight and furthermore preferably in an amount in a range of from 0.25 to about 20% by weight, in each case based on the weight of the total processing aid.

A processing aid comprising one or more of the above-mentioned additional ingredients prepared in accordance with the invention, when used in the processing of polymer compositions, not only exhibits an effect of improving processing but, depending upon the nature and amount of the additional ingredients, may exhibit further actions which extend over a long period of time after the processing. Especially when a processing aid prepared in accordance with a process of the invention comprises a suitable amount of compounds having a stabilizing action, the processing aid according to the invention can also be termed, for example, a “stabilizer”.

Within the scope of the process of the invention, the above-mentioned additional ingredients can be added to the reaction mixture either before or during polymerization or can be mixed with the product after polymerization. The addition of additional ingredients before or during polymerization requires that the additional ingredients do not affect the course of polymerization or at least do not affect the course of polymerization in an undesirable way. When the additional ingredients are added to the product after polymerization, that addition is effected preferably while the product is still in the molten state.

The present invention accordingly relates also to a processing aid which can be obtained in accordance with a process described in the context of this text. A processing aid according to the invention preferably comprises a polymer or a mixture of two or more polymers, such as are obtainable by the polymerization of one of the above-described monomer components, a solvent component as described above and optionally one of the above-described additional ingredients or a mixture of two or more thereof. The comments made in relation to carrying out the process according to the invention in the context of this text, especially the comments relating to the ingredients used within the scope of the process of the invention, are to be applied analogously in their entirety to the composition of a processing aid according to the invention.

The processing aids described in this text, especially the processing aids described in this text that comprise one or more stabilizers as additional ingredients, are suitable for use in the processing of polymer compositions.

“Polymer compositions” are to be understood as meaning compositions that comprise a polymer or a mixture of two or more polymers that have not been produced in the context of the process of the invention. It is immaterial whether or not the polymers contained in a “polymer composition” are identical to one or more of the polymers produced in the context of the process of the invention. Within the scope of a preferred embodiment of the present invention, however, a composition termed a “polymer composition” comprises at least one polymer that differs in chemical composition from at least one polymer produced in the context of the present process.

Within the scope of a preferred embodiment of the present invention, the processing aids according to the invention are used in the processing of polymers that have been obtained by polymerization of monomers having at least one olefinically unsaturated double bond. Such polymers are termed “vinyl polymers” in the context of this text.

The present invention therefore relates also to a polymer composition, at least comprising a vinyl polymer and a processing aid prepared in accordance with a process of the invention or a processing aid according to the invention.

Within the scope of a preferred embodiment of the present invention, a polymer composition according to the invention comprises at least one halogenated polymer. Within the scope of a further preferred embodiment of the present invention, a polymer composition according to the invention comprises more than 50% by weight of a halogenated polymer or a mixture of two or more halogenated polymers, for example more than 70% by weight or more than 90% by weight, based on the polymers contained in the polymer composition.

The present invention therefore relates also to a polymer composition according to the invention described in the context of this text that comprises a halogenated polymer.

Within the scope of an especially preferred embodiment of the present invention, a polymer composition according to the invention comprises halogen-containing polymers. Examples of such halogen-containing polymers are polymers of vinyl chloride, vinyl resins containing vinyl chloride units in the polymer backbone, copolymers of vinyl chloride and vinyl esters of aliphatic acids, especially vinyl acetate, copolymers of vinyl chloride with esters of acrylic and methacrylic acid or acrylonitrile or mixtures of two or more thereof, copolymers of vinyl chloride with diene compounds or unsaturated dicarboxylic acids or anhydrides thereof, for example copolymers of vinyl chloride with diethyl maleate, diethyl fumarate or maleic anhydride, post-chlorinated polymers and copolymers of vinyl chloride, copolymers of vinyl chloride and vinylidene chloride with unsaturated aldehydes, ketones and other compounds such as acrolein, crotonaldehyde, vinyl methyl ketone, vinyl methyl ether, vinyl isobutyl ether and the like, polymers and copolymers of vinylidene chloride with vinyl chloride and other polymerizable compounds, such as those already mentioned above, polymers of vinyl chloroacetate and dichlorodivinyl ether, chlorinated polymers of vinyl acetate, chlorinated polymeric esters of acrylic acid and α-substituted acrylic acids, chlorinated polystyrenes, for example polydichlorostyrene, chlorinated polymers of ethylene, polymers and post-chlorinated polymers of chlorobutadiene and copolymers thereof with vinyl chloride and also mixtures of two or more of the mentioned polymers or polymer mixtures that contain one or more of the above-mentioned polymers.

Within the scope of a further preferred embodiment of the present invention, the processing aids according to the invention are used in the production of moulded articles of PVC-U, such as window profiles, industrial profiles, tubes and plates.

Also suitable for treatment with the processing aids according to the invention are the graft polymers of PVC with EVA, ABS or MBS. Preferred substrates for such graft copolymers are also the afore-mentioned homo- and co-polymers, especially mixtures of vinyl chloride homopolymers with other thermoplastic or elastomeric polymers, especially blends with ABS, MBS, NBR, SAN, EVA, CPE; MBAS, PAA (polyalkyl acrylate), PAMA (polyalkyl methacrylate), EPDM, polyamides or polylactones.

Likewise suitable for treatment with the processing aids according to the invention are mixtures of halogenated and non-halogenated polymers, for example mixtures of the above-mentioned non-halogenated polymers with PVC, especially mixtures of polyurethanes and PVC.

Furthermore, it is also possible for recyclates of chlorine-containing polymers to be treated with the processing aids according to the invention, in principle any recyclates of the above-mentioned halogenated polymers being suitable for this purpose. PVC recyclate, for example, is suitable in the context of the present invention.

Within the scope of a preferred embodiment of the present invention, a polymer composition according to the invention comprises the processing aid according to the invention in an amount of from 0.1 to 20 phr, especially from about 0.5 to about 15 phr or from about 1 to about 12 phr. The unit phr represents “per hundred resin” and thus relates to parts by weight per 100 parts by weight of polymer.

As already mentioned above, the processing aids according to the invention are also suitable for the stabilization of polymer compositions, especially for the stabilization of polymer compositions comprising halogen-containing polymers, depending upon the nature and the amount of the additional ingredients contained therein.

The present invention therefore relates also to a process for stabilizing halogen-containing polymers in which a halogen-containing polymer or a mixture of two or more halogen-containing polymers or a mixture of one or more halogen-containing polymers and one or more halogen-free polymers is mixed with a processing aid according to the invention.

The mixing together of polymer or polymers and the processing aid according to the invention can in principle be effected at any time before or during the production or processing of the polymer. For example, the processing aid can be mixed into the pulverulent polymer prior to processing. It is equally possible, however, to add the processing aid to the polymer or polymers in the softened or molten state. Furthermore, the processing aid can be added as early as during the polymerization of the vinyl polymer or immediately after the polymerization of the vinyl polymer, for example during the polymerization of PVC or immediately after the polymerization of PVC, e.g., to give a hot S-PVC slurry.

In the context of a process according to the invention for the production of a polymer composition according to the invention, for example, a polymer composition is mixed with a processing aid according to the invention.

Within the scope of the present invention, a polymer composition according to the invention can comprise a vinyl polymer or a mixture of two or more vinyl polymers, preferably halogenated vinyl polymers, a mixture of polymers and solvent component prepared in accordance with a process of the invention, and also further additional ingredients, for example additional ingredients as already described in the context of this test. Within the scope of the present invention, the additional ingredients may have been introduced into the polymer composition by means of the processing aid according to the invention or the additional ingredients may have been mixed with the polymer composition and the processing aid in one or more separate steps. It is also possible, for example, for some of the desired additional ingredients to be introduced into the polymer composition by means of the processing aid and for a further portion of the additional ingredients to be mixed with the polymer composition and the processing aid in one or more separate steps.

In the context of a process according to the invention, one or more additional ingredients can be added to the polymer composition in addition to the processing aid.

The processing aid is preferably added to the polymer composition in an amount of from 0.1 to 20% by weight, based on the polymer contained in the polymer composition.

Within the scope of the present invention, special preference is given to a process in which at least 50% by weight of the vinyl polymer is vinyl-chloride-based.

A polymer composition according to the invention can be brought into a desired form in known manner. Suitable processes are, for example, calendering, extrusion, injection-moulding, sintering, extrusion blowing or the plastisol process. A polymer composition according to the invention can also be used, for example, in the production of foamed materials. In principle, the polymer compositions according to the invention are suitable for the production of hard or soft PVC, especially for the production of PVC-U.

A polymer composition according to the invention can be processed to form moulded articles. The present invention therefore relates also to moulded articles, at least comprising a processing aid according to the invention or a polymer composition according to the invention.

The term “moulded article” in the context of the present invention in principle includes any three-dimensional structures that can be produced from a polymer composition according to the invention. In the context of the present invention the term “moulded article” includes, for example, wire sheathings, automobile components, for example automobile components such as are used in the interior of the automobile, in the engine space or on the outer surfaces, cable insulations, decorative films, agricultural films, hoses, shaped sealing elements, office films, hollow bodies (bottles), packaging films, (deep-draw films), blown films, tubes, foamed materials, heavy duty profiles (window frames), light wall profiles, structural profiles, sidings, fittings, plates, foamed panels, co-extrudates having a recycled core, or housings for electrical apparatus or machinery, for example computers or household appliances.

Further examples of moulded articles that can be produced from a polymer composition according to the invention are synthetic leather, floor coverings, textile coatings, wallcoverings, coil coatings and underseals for motor vehicles.

The present invention relates also to the use of a processing aid according to the invention as an additive in the processing of a thermoplastic composition based on vinyl polymers.

The invention will now be explained in greater detail with reference to test methods and non-limiting examples.

### Test Methods

### Determination of the Softening Time

The determination is carried out on a Brabender measuring kneader at a temperature of 170° C. 34 g of the thermoplastic moulding material were used for determining the softening time.

### EXAMPLES

### Preparation of the Additives

### Example 1

150 g of beef tallow, 60 g of polyethylene wax, 45 g of oxidised polyethylene wax (in total a mixture of Baerolub GTS, Baerolub PA and Baerolub PA25) are weighed into a 1.4 litre steel reactor equipped with an oil bath thermostat, an anchor stirrer and a reflux condenser. The mixture is then melted under nitrogen at 100° C. and mixed with the anchor stirrer at 100 rev/min. To the resulting solution there is added dropwise by means of a metering pump a mixture of 300 g of methyl methacrylate (MMA) and 1.3 g of dibenzoyl peroxide. The throughflow rate of the pump is adjusted to 2.5 ml per minute. When the addition of MMA is complete, stirring is carried out for a further one hour at 100° C. Any residual monomer still present is driven out of the mixture by a stream of nitrogen.

### Examples 2 to 5

The procedure is analogous to Example 1, the reaction temperatures being varied between 110° C. and 150° C.

### Example 6

The procedure is analogous to Example 1, the throughflow rate of the pump being set to 0.5 ml per minute.

### Example 7

The procedure is analogous to Example 1, a mixture of 80 parts by weight methyl methacrylate and 20 parts by weight n-butyl acrylate being used as monomer.

### Example 8

The procedure is analogous to Example 1, a mixture of 80 parts by weight methyl methacrylate and 20 parts by weight n-butyl methacrylate being used as monomer.

### Example 9

150 g of beef tallow, 60 g of polyethylene wax and 45 g of oxidised polyethylene wax (see above) are weighed into a 1.4 litre steel reactor equipped with an oil bath thermostat, an anchor stirrer and a reflux condenser. The mixture is then melted under nitrogen at 130° C. and mixed with the anchor stirrer at 100 rev/min. To the resulting solution there are added dropwise by means of a metering pump a first mixture of 198 g of methyl methacrylate (MMA) and 1.3 g of dibenzoyl peroxide and then a second mixture of 42 g of MMA, 60 g of n-butyl acrylate and 0.5 g of dibenzoyl peroxide. The throughflow rate of the pump is adjusted to 2.5 ml per minute. When the addition of MMA is complete, stirring is carried out for a further one hour at 130° C. Any residual monomer still present is driven out of the mixture by a stream of nitrogen.

### Preparation of a Stabilizer Composition

### Example 10

The following further stabilizers were added to the product of Example 6 while still in the molten state in the reaction vessel:

| | |
|---|---|
| β-diketone (calcium acetylacetonate) | 60 g |
| BS ASM 104¹ | 60 g |
| antioxidant² | 42 g |
| hydrotalcite as inorg. acid absorber | 150 g |
| zinc stearate | 300 g |
| organophosphite³ | 30 g |

¹= trihydroxyethyl isocyanurate
²= Irganox 1076 (Ciba)
³= Rhodiastab 55 P (Rhodia)

For cooling, the resulting molten stabilizer composition was then discharged in a thin layer and, after cooling, broken into flakes.

### Comparative Example 1

As a comparative test, the following products were added to a melt of 150 g of beef tallow, 60 g of polyethylene wax and 45 g of oxidised polyethylene wax:

| | |
|---|---|
| β-diketone (calcium acetylacetonate) | 60 g |
| BS ASM 104¹ | 60 g |
| antioxidant² | 42 g |
| hydrotalcite as inorg. acid absorber | 150 g |
| zinc stearate | 300 g |
| organophosphite³ | 30 g |

It was then attempted to incorporate a conventional flow aid (Baerorapid 10 F, Baerlocher) into the resulting melt. A rubber-like mass was obtained which was not capable of further processing. The comparison test shows that the combination of lubricants, processing aids and stabilizers in a single composition is possible only because the processing agents are produced by polymerization in the molten lubricant.

This can be explained, for example, by the fact that the processing aids produced by emulsion polymerization known from the prior art have a globular geometry with a hydrophilic surface (emulsifier). Incorporation into a stabilizer mixture, inter alia comprising a lubricant, is thus rendered more difficult. High shear forces are therefore required for their incorporation. This is not the case with the processing aid according to the invention.

### Processing of Thermoplastic Composition with the Additives

The various additives were tested in the following thermoplastic composition:

| | Examples 1-9 |
|---|---|
| Substance | Parts |
| PVC (K value = 68) | 100 |
| Impact strength modifier¹⁾ | 7 |
| Titanium dioxide | 4 |
| Chalk | 3 |
| Calcium acetylacetonate | 0.2 |
| BS ASM 104 | 0.2 |
| Antioxidant²⁾ | 0.14 |
| Hydrotalcite | 0.5 |
| Zinc stearate | 1.0 |
| Organophosphite³⁾ | 0.1 |
| Product from Example 1 to 9 | 1.83 |

¹⁾EST 4 Baerorapid, Baerlocher
²⁾Irganox 1040
³⁾Rhodiastab 5

The different mixtures were processed on a heating/cooling mixer to form dry blends and then extruded to form strips on a single-screw extruder. The following softening times were determined:

| Formulation | Softening time [min] |
|---|---|
| 1 | 1.9 |
| 2 | 1.9 |
| 3 | 2.0 |
| 4 | 1.9 |
| 5 | 1.9 |
| 6 | 2.1 |
| 7 | 1.7 |
| 8 | 1.8 |
| 9 | 1.8 |

1. A process for the preparation of a processing aid for vinyl polymers, which can be used without prior drying steps, comprising the step of:
polymerizing a (meth)acrylate monomer having from 1 to 3 carbon atoms in the alcohol radical or a monomer mixture comprising the (meth)acrylate monomer in the presence of a meltable additive to form a reaction product, the meltable additive being present at least in a softened state under polymerization conditions and serving as a solvent in the polymerization of the (meth)acrylate monomer or monomer mixture,
wherein said polymerizing step is a free radical polymerization step and occurs at a temperature above the softening temperature of the meltable additive.

2. The process according to claim 1, wherein said polymerizing step comprises polymerizing a monomer mixture comprising the (meth)acrylate monomer and one or more additional monomers in the presence of the meltable additive.

3. The process according to claim 1, wherein said polymerizing step comprises polymerizing the (meth)acrylate monomer or monomer mixture in the presence of two or more meltable additives to form the reaction product, the two or more meltable additives being present at least in a softened state under polymerization conditions and serving as a solvent in the polymerization of the (meth)acrylate monomer or monomer mixture, said polymerizing step occurring at a temperature above the softening temperature of the two or more meltable additives.

4. The process according to claim 1, wherein the polymerizing step occurs at a temperature of at least 80° C.

5. The process according to claim 1, wherein the polymerizing step comprises providing the monomer or the monomer mixture in a ratio by volume of from 1:500 to 1:50, based on the volume of the meltable additive, during the reaction period.

6. The process according to claim 1, wherein the polymerizing step comprises polymerizing a monomer mixture comprising at least 50% by weight methyl(meth)acrylate.

7. The process according to claim 1, wherein the meltable additive comprises at least one triglyceride.

8. The process according to claim 7, wherein the meltable additive further comprises at least one plasticizer for vinyl polymers.

9. The process according to claim 1, further comprising the step of adding a stabilizer for vinyl polymers before or during said polymerizing step or to the reaction product.

10. The process according to claim 1, wherein the meltable additive is in a liquid state under polymerization conditions.

11. The process according to claim 1, wherein the meltable additive has a melting point of at least 30° C.

12. A processing aid prepared according the method of claim 1.

13. A polymer composition, comprising:
a vinyl polymer; and
a processing aid prepared by polymerizing a (meth)acrylate monomer having from 1 to 3 carbon atoms in the alcohol radical or a monomer mixture comprising the (meth)acrylate monomer in the presence of a meltable additive to form a reaction product, the meltable additive being present at least in a softened state under polymerization conditions and serving as a solvent in the polymerization of the (meth)acrylate monomer or monomer mixture,
wherein said polymerizing step is a free radical polymerization step and occurs at a temperature above the softening temperature of the meltable additive.

14. The polymer composition according to claim 13, wherein the vinyl polymer includes a halogenated polymer.

15. A process for preparing a polymer composition, comprising the steps of:
polymerizing a (meth)acrylate monomer having from 1 to 3 carbon atoms in the alcohol radical or a monomer mixture comprising the (meth)acrylate monomer in the presence of a meltable additive to form a processing aid, the meltable additive being present at least in a softened state under polymerization conditions and serving as a solvent in the polymerization of the (meth)acrylate monomer or monomer mixture, and said polymerizing step being a free radical polymerization step and occuring at a temperature above the softening temperature of the meltable additive; and
adding the processing aid to a thermoplastic composition comprising a vinyl polymer.

16. The process according to claim 15, wherein said adding step comprises adding the processing aid to a thermoplastic composition comprising a mixture of two or more vinyl polymers.

17. The process according to claim 15, wherein said adding step comprises adding the processing aid in an amount of from 0.1 to 20% by weight, based on the polymer contained in the thermoplastic composition.

18. The process according to claim 15, wherein at least 50% by weight of the vinyl polymer is vinyl chloride-based.
